(19) United States
(12) Patent Application Publication
(10) Pub. No.: US 2007/0280792 A1
(43) Pub. Date: Dec. 6, 2007

(54) Polycrystalline diamond tool for cutting

(75) Inventors: William J. Kochan, Schaumburg, IL (US); Jason A. Belec, Gurnee, IL (US)

Correspondence Address: SCHIFF HARDIN, LLP;PATENT DEPARTMENT, 6600 SEARS TOWER, CHICAGO, IL, 60606-6473, US

(73) Assignee: Onsrud Cutter LP

(21) Appl. No.: 11/445,836

(22) Filed: Jun. 1, 2006

(51) Int. Cl. B23C 5/10

(52) U.S. Cl. 407/53

(57) ABSTRACT

A tool has a shaft and a tip on the shaft. The tip supports rougher and chipbreaker finisher wings which, for example, may be polycrystalline diamond wings. Also, the rougher and chipbreaker finisher wings may be arranged, for example, to provide either upshear or downshear forces. As another example, both upshear and downshear rougher and chipbreaker finisher wings may be arranged to produce corresponding upshear and downshear forces.

### BACKGROUND OF THE INVENTION

1. Field of the Invention

The present invention according to one embodiment relates generally to a tool for cutting made of polycrystalline diamond. The present invention according to a different embodiment relates generally to a system for cutting made of upshear and downshear forces.

2. Description of the Related Art

Tools for cutting used in industrial milling applications are known as endmills. A broad category of end milling tools exist, such as flat bottom, ball nose, radius, inverted radius, and chamfer tools. Each category may be further divided by application and geometry. Traditionally, endmills have been made from solid carbide or high speed steel (HSS).

One drawback to HSS is its lack of durability. Although HSS provides fast feed rates and a high finish quality, tools that contain these materials are not wear-resistant. Thus, HSS must be replaced on a regular basis.

As a result, there is a need for a cutting tool that is wear-resistant, and at the same time provides a fast feed rate and high quality finish. To increase the life of HSS, tools are sometimes coated. One example of such coating includes titanium nitride. Most coatings decrease wear and friction on the tool. Further, the coating decreases the temperature associated with the cutting process, and therefore increases the life of the tool.

Another approach used by machinists to increase wear-resistance, while at the same time preserving the beneficial properties of HSS, is tungsten carbide. Tungsten carbide's extreme hardness makes it useful in the manufacture of cutting tools. Further, tungsten carbide is a cheaper manufacturing alternative to diamond. Carbide cutting surfaces prove useful when cutting tough materials. Moreover, carbide cutting surfaces work well in situations where other tools would wear away, such as during high-quantity production runs.

However, cutting with carbide can be difficult because carbide is more brittle than other tool materials, making it susceptible to chipping and breaking. Furthermore, tools made completely of carbide are quite expensive.

The inventors have recognized a problem with the cutting tools and endmills currently on the market in that the beneficial properties of wear-resistance, low expense, fast feed rate, and/or high quality finish are not present in the cutting tool.

### SUMMARY OF THE INVENTION

The present invention according to one embodiment relates generally to a tool for cutting comprising the following: a shaft; a tip on the shaft having three flutes such that each flute has an upshear flute and a downshear flute; rougher and chipbreaker finisher wings on said upshear flutes; and, rougher and chipbreaker finisher wings on said downshear flutes.

The present invention according to a different embodiment relates generally to a system for cutting comprising the following: a shaft; a tip on the shaft; and, four PCD chipbreaker finisher wings and two PCD rougher wings included on said tip.

### BRIEF DESCRIPTION OF THE DRAWINGS

FIG. 1 is a left side view showing the component parts of a tool for cutting and tool cutting system.

FIG. 2 is an end view showing the component parts of a tip used in a tool for cutting and tool cutting system.

FIG. 3 is a top view showing the component parts of a tool for cutting and tool cutting system.

FIG. 4 is a right side view showing the component parts of a tool for cutting and tool cutting system.

FIG. 5 is an enlarged detail of a chip breaker finisher wing edge.

FIG. 6 is an enlarged detail of an upshear chip breaker finisher wing edge.

### DETAILED DESCRIPTION OF THE PREFERRED EMBODIMENTS

According to one embodiment of the present invention, a tool for cutting is made of polycrystalline diamond (PCD) that combines rougher, chipbreaker finisher, and compression geometries into one tool. The tool, for example, is a three flute cutter having three upshear flutes and three downshear flutes. The upshear and downshear flutes each possess one rougher wing, which reduces cutting forces, allowing the tool to achieve a higher feed rate, and the two chipbreaker finisher wings create a smooth edge finish. By combining these cutting geometries, the tool of this embodiment is formed that can feed faster than any PCD tool currently on the market while producing a clean edge finish.

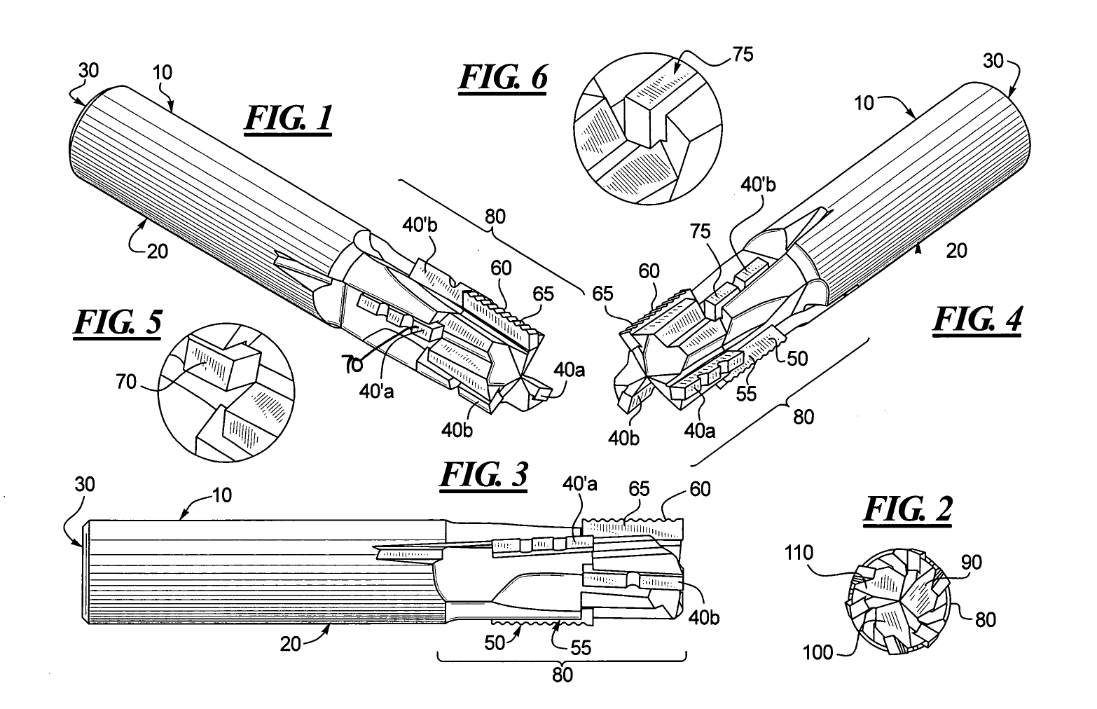

As shown in FIG. 1, a compression tool 10 has a body 20 in the shape of a round shaft. However, other shapes could be used to form the body of the tool 10, including, but not limited to, rectangular or other angular shapes. The body 20 of the tool 10 can have varying widths, depending on the size of the intended tool holder, or preferences of the user. Further, an end 30 of the tool can be shaped or formed to fit with several tool holders, depending on the user's preferences. FIG. 1 shows the end 30 as a round, flat end. However, other end shapes could include, but are not limited to, square, oval, spindle, or other angular shapes. In one embodiment, the body 20 is made of solid carbide. In another embodiment, the body 20 is made of high speed steel. However, the body can be made of other materials including those that may become available in the future.

As shown in FIG. 2, a tip 80 of the tool 10 is made of three flutes 90, 100, and 1 10. Each flute is located 120° from each of the other flutes. As shown in FIG. 2, the flute 90 is located 120° apart from the flute 110 and 120° from the flute 100 around the tip 80. The same follows for the flute 100 and the flute 110. However, an alternative embodiment might include each flute staggered differently around the tip so as to maximize other preferable qualities of a tool for cutting or a cutting system.

In an embodiment, the flutes 90, 100, and 110 are cut directly into the body 20 of the tool 10. In this way, the flutes 90, 100, and 110 are made of the same material as the body. In another embodiment, the flutes 90, 100, and 110 are made of solid carbide. In another embodiment, the flutes 90, 100, and 110 are made of high speed steel.

Referring to FIGS. 3 and 4, each of the flutes 90, 100, and 110 of the tip 80 are comprised of an upshear flute and a downshear flute. In one embodiment, the downshear flutes have two chipbreaker finisher wings 40′a and 40′b. As shown, the chipbreaker finisher wing 40′a is comprised of one edge, and the chipbreaker finisher wing 40′b is comprised of one edge. FIG. 1 shows an edge 70 of the chipbreaker finisher wing 40′a. FIG. 5 is an enlarged view of the edge 70. The edge 70 contributes to lower cutting forces and increased feed rates by reducing chip size with its rectangular geometry. As a result, the edge 70 allows for ease of chip removal from the cutting path of the tool 10 and the tip 80. Other geometries can be used for the edge 70 that allow chip size reduction and removal from the cutting path.

FIG. 4 shows an edge 75 of the chipbreaker finisher wing 40′b. FIG. 6 is an enlarged view of the edge 75. The edge 75 contributes to increased feed rates by reducing chip size with its rectangular geometry. As a result, the edge 75 allows for ease of chip removal from the cutting path of the tool 10 and the tip 80. Other geometries can be used for the edge 75 that allow chip size reduction and removal from the cutting path.

In an embodiment, the upshear flutes of each of the flutes 90, 100, and 110 of the tip 80 also have two chipbreaker finisher wings 40a and 40b, with the same geometry and structure as those described for the chipbreaker finisher wings 40′a and 40′b.

In an embodiment, the chipbreaker finisher wings 40′a, 40a, 40′b, and 40b are made of polycrystalline diamond (PCD). PCD is a hard, synthetic diamond product that is abrasive resistant when used in all directions for tooling. PCD tipped tools are exceptionally resistant to wear. For example, PCD tool life can exceed carbide cutting tool life by two to three times. Further, PCD is versatile and cheap compared to its contemporaries in the tooling industry, because tools made of PCD last longer, thereby reducing replacement costs.

In an alternative embodiment, the chipbreaker finisher wings 40′a, 40a, 40′b, and 40b are made of monocrystalline diamond (“diamond”). Diamond is best suited to produce very fine and precise finishes as required in the manufacture of jewelry, plastic contact lenses, computer memory discs, or aluminum camera parts. However, this list does not limit the applications that the tool tip 80 can be used for when made of diamond.

In another embodiment, the chipbreaker finisher wings 40′a, 40a, 40′b, and 40b are made of cubic boron nitride (CBN). CBN is an artificially synthesized material exceeded in hardness only by diamond. CBN permits cutting at high feeds and speeds, and maintains a sharp cutting edge which produces high quality finishes.

Both PCD and CBN are available in a large variety of shapes and sizes. As a result, the chipbreaker finisher wings 40′a, 40a, 40′b, and 40b of the tip 80 can be made of any shape and size, depending on the manufacturer's needs and/or user's preferences. Further, CBN is available in several different grades, all of which can be used in the chipbreaker finisher wings 40′a, 40a, 40′b, and 40b of the tip 80 of the invention.

In another embodiment, the chipbreaker finisher wings 40′a, 40a, 40′b, and 40b are made of ceramic. Further, the chipbreaker finisher wings 40′a, 40a, 40′b, and 40b can be made of any materials not created yet that permit cutting at high feeds and high speeds, and maintains a sharp cutting edge which produces high quality finishes.

As shown in FIG. 1, the chipbreaker finisher wings 40′a and 40′b are offset from one another to a degree that produces a finished surface. In a preferred embodiment, chipbreaker finisher wings 40′a and 40′b are offset to a degree, such as 120°, that produces a finished surface required by a CNC operator. However, other degrees of offset can be used to produce the desired surface finish, as embodied in the present invention.

In an embodiment, a pattern of the chipbreaker finisher wings 40′a, 40a, 40′b, and 40b are comprised of four chipbreaker finisher wings, arranged in an offset pattern so that the chipbreaker finisher wings 40′a and 40′b produce downshear forces that force chips down in a cut, and the chipbreaker finisher wings 40a and 40b produce upshear forces that force chips up in the cut. In this way, opposite forces work to break up and clear chips out of the cutting edge surface, producing a finished cut.

In an embodiment, the chipbreaker finisher wings 40′a, 40a, 40′b, and 40b on the tip 80 are mounted to the body 20 of the tool 10 at 90° angles.

In an alternative embodiment, the pattern of chipbreaker finisher wings 40′a, 40a, 40′b, and 40b can be changed depending on the application that the tool 10 is being used for by the user. For example, the tool 10 can include additional chipbreaker finisher wings besides the chipbreaker finisher wings 40′a, 40a, 40′b, and 40b so that tougher or larger chips can be cleared from the cut easier.

As shown in FIGS. 1, 3, and 4, the upshear flutes of the flutes 90, 100, and 110 also include one rougher wing 60 with a scalloped edge 65 that is shaped in a way to break cutting forces. This allows increased feed rates. The scalloped edge 65 also breaks the chips down further. As a result, the life of the upshear cutting edge is extended over traditional PCD tools.

As shown in FIGS. 3 and 4, the downshear flutes of the flutes 90, 100, and 100 includes one rougher wing 50 with a scalloped edge 55 that is shaped in a way to break cutting forces. This allows increased feed rates. The scalloped edge 55 breaks the chips down further. As a result, the life of the downshear cutting edge is extended over traditional PCD tools.

In an embodiment, the rougher wings 50 and 60 on the tip 80 are mounted to the body 20 of the tool 10 at 90° angles.

In a preferred embodiment, the shape of the edges 55 and 65 is scalloped. However, alternative embodiments of the present invention include other shapes which allow for increased feed rates, chip breakage, and increased life of upshear and downshear cutting edges.

In an embodiment, the rougher wings 50 and 60 are located 180° degrees apart from one another around the tip 80. The rougher wing 60 produces upshear forces, while the rougher wing 50 produces downshear forces. By locating the rougher wings 50 and 60 on opposite sides of the tip 80, the upshear forces and the downshear forces are allowed to produce two different forces without resistance.

As shown in FIGS. 3 and 4, the rougher wing 50 and the rougher wing 60 are located 180° apart from one another. In an alternative embodiment, additional rougher wings could be inserted into the tool 10 and the tip 80 in order to produce a more finished cut and a finer cut. In another embodiment, less rougher wings could be inserted into the tool 10 and the tip 80 in order to produce a less finished cut and a coarser cut.

In an embodiment, the downshear forces produced by the chipbreaker finisher wings 40′a and 40′b and the downshear forces produced by the rougher wing 50 provide for a chip free top edge. The upshear forces produced by the chipbreaker finisher wings 40a and 40b and the upshear forces produced by the rougher wing 60 provide for a chip free bottom edge. These chip free edges are especially advantageous for laminated wood products. However, these chip free edges are useful for any cutting application, and thus the cutting tool 10 can be used in various applications to produce a high quality finish.

The present cutting tool and system for cutting is intended for use primarily in wood cutting applications, but it is envisioned that the tool 10 and system may be used in a variety of other applications, including aluminum and aluminum alloy cutting, copper, brass and bronze alloy cutting, zinc and magnesium alloy cutting, gold and silver cutting, carbon and graphite cutting, ceramics cutting, plastics and rubber cutting, fiberglass composites cutting, chipboard and fiberboard cutting, graphite composites cutting, composite plastics, composites in general, or any new material created in the future.

In an alternative embodiment, the tool 10 and system for cutting may be used in a variety of other applications, including cutting of any of the following: alloy steels, carbon steel alloys, die steel, high speed steel, chilled cast iron, Ni Hard, forged steel, meehanite iron, and moly chrome steel rolls. Many other cutting applications are also possible, including those currently available and those available in the future.

The present invention has been described in specific detail and with particular reference to its preferred embodiments; however, it will be apparent to those having skill in the art that modifications and changes can be made thereto without departing from the spirit and scope of the invention.

We claim:

1. A tool for cutting comprising:
a shaft;
a tip on the shaft having three flutes;
each flute having an upshear flute and a downshear flute;
rougher and chipbreaker finisher wings on said upshear flutes; and,
rougher and chipbreaker finisher wings on said downshear flutes.

2. The tool for cutting of claim 1, wherein said rougher and chipbreaker finisher wings on said downshear flutes include two chip breaker finisher wings and one rougher wing and wherein said rougher and chipbreaker finisher wings on said upshear flutes include two chip breaker finisher wings and one rougher wing.

3. The tool for cutting of claim 2 wherein the chipbreaker finisher wings on the upshear and downshear flutes are comprised of a rectangular edge, and wherein the rougher wings on the upshear and downshear flutes are comprised of a scalloped edge.

4. The tool for cutting of claim 2 wherein the rougher and chipbreaker finisher wings on the downshear and upshear flutes comprise corresponding PCD wings.

5. The tool for cutting of claim 1, wherein said shaft is made of high speed steel.

6. The tool for cutting of claim 5, wherein said flutes are made of high speed steel.

7. The tool for cutting of claim 1, wherein said shaft is made of solid carbide.

8. The tool for cutting of claim 7, wherein said flutes are made of solid carbide.

9. The tool for cutting of claim 1, wherein said chipbreaker finisher wings are made of cubic boron nitride.

10. The tool for cutting of claim 9, wherein said rougher wings are made of cubic boron nitride.

11. The tool for cutting of claim 1, wherein each flute is located 120° apart from said other flutes.

12. The tool for cutting of claim 1, wherein said chipbreaker finisher wings are made of diamond.

13. The tool for cutting of claim 12, wherein said rougher wings are made of diamond.

14. The tool for cutting of claim 1, wherein said chipbreaker finisher wings are made of PCD.

15. The tool for cutting of claim 14, wherein said rougher wings are made of PCD.

16. The tool for cutting of claim 2, wherein said rougher wing included on said downshear flutes is located 180° apart from said rougher wing included on said upshear flutes.

17. A system for cutting comprising:
a shaft;
a tip on the shaft; and,
four PCD chipbreaker finisher wings and two PCD rougher wings included on said tip.

18. The system of claim 17, wherein said shaft is made of solid carbide.

19. The system of claim 17, wherein said shaft is made of high speed steel.

20. The system of claim 17, wherein each wing is located 120° apart from said other wings.

21. The system of claim 17 wherein the chipbreaker finisher wings are comprised of a rectangular edge, and wherein the rougher wings are comprised of a scalloped edge.
